(19) United States
(12) Patent Application Publication
(10) Pub. No.: US 2002/0145033 A1
(43) Pub. Date: Oct. 10, 2002

(54) Debris collection tray and method of making and installing same

(76) Inventor: Curtis E. Dakolios, Simi Valley, CA (US)

Correspondence Address: Jack C. Munro, Agent of Record, Suite 225, 28720 Roadside Drive, Agoura Hills, CA, 91301, US

(21) Appl. No.: 09/824,918

(22) Filed: Apr. 4, 2001

(51) Int. Cl. B65D 5/46; A46B 17/00; B05C 21/00; A47L 23/14; A47L 25/00; A47G 29/08; A47L 13/52

(52) U.S. Cl. 229/117.23; 15/257.01; 15/257.1

(57) ABSTRACT

A debris collection tray and method of making and installing of same which comprises an elongated, thin, sheet material member which is constructed of a pliable material so that the lower portion of the member can be bent to a transverse position relative to the upper portion member. An adhesive strip or other form of temporary securement is to be applied on the back surface of the member with adhesive to be applied to a vertical wall surface at a selected location so that the lower portion of the member will function as a trough and catch falling debris.

### BACKGROUND OF THE INVENTION

1. Field of the Invention

The subject matter of this invention relates in general to debris collection devices and more particularly to a debris collection tray that is designed to be mounted on a vertical wall or any surface directly below an area where an operation is to be performed, such as drilling a hole into the wall surface, sanding of the wall surface, scraping of the wall surface, painting, cleaning of work surfaces such as counter tops or some other falling debris generating operation.

2. Description of the Related Art

Within homes and businesses, it is common to perform operations on walls. A typical operation might be sanding a particular area or drilling a hole in a particular area for mounting a picture. Another operation might be painting the wall. Still another operation might be patching of a hole which includes scraping the wall. Each of these operations will inherently generate falling debris. Typical falling debris would be small particles, such as swarf, dust and chips. When patching a hole, the falling debris frequently constitutes excess patching material. When painting, the falling debris comprises splatter.

Debris can also be generated in the form of foreign objects such as fasteners dropped during manufacture of equipment, for example, aircraft assembly, automobile assembly, engine assembly, and so forth. Debris can also be generated by mechanics when repairing automobiles, trucks and like vehicles. Debris could also occur in automobile and truck body repair services.

Most often, there has not been used any type of device to collect any type of falling debris in such a situation. The debris is permitted to fall and then it is cleaned up from the floor or carpet on which the debris gathers. In some cases, the debris can permanently stain the floor or carpet which is not particularly desirable. In other instances, the debris is so small that it is very difficult to remove and is almost impossible to collect all of the debris. It would be desirable to design a device that could be mounted on the exterior structure just below where the operation is occurring with this device functioning to collect falling debris from the operation.

### SUMMARY OF THE INVENTION

The first embodiment of this invention comprises an elongated, thin, sheet material member which has a front surface and a back surface. The member is pliable so as to be bendable from an initial flat or other preformed shape to a usable shape. The member can be generally divided into a top area and a bottom area with the top area including a temporary securement to facilitate attachment to an exterior structure. The bottom area is capable of being deflected and remain in that deflected state assuming a transverse position relative to the top area. The bottom area can be formed into a trough shape which will function to collect falling debris.

A further embodiment of this invention is where the debris collection tray is constructed from a rectangularly shaped sheet material member.

A still further embodiment of this invention comprises a debris collection tray where the means of temporary securement of the member on the exterior structure is mounted on the member with this means for temporary securement being located at the top area of the member.

A still further embodiment of this invention is where the exterior structure comprises a wall.

A still further embodiment of this invention is where the means for temporary securement comprises an adhesive strip mounted on the back surface of the member.

A still further embodiment of this invention is directed to the method of making and installing a debris collection tray which comprises forming an elongated, thin, sheet material member having an upper edge and a lower edge where the member is constructed to be pliable and where the member has an upper area which includes the upper edge and a lower area which includes the lower edge. Securement is attached to the member at the upper edge. The member is mounted by the securement onto an exterior structure and at a selected location. The method includes bending of the member by moving of the lower area outwardly assuming a transverse position relative to the upper area with the lower area defining a trough which is able to collect falling debris.

A still further embodiment of this invention is where the member is formed of a rectangular shape.

A still further embodiment of method of making and installing a debris collection tray of this invention is where the securement comprises an adhesive strip.

A still further embodiment of this invention comprises a method of making a debris collection tray which comprises forming of an elongated, thin, sheet material member having an upper edge and a lower edge where the member is constructed to be pliable and the member has an upper area which includes the upper edge and a lower area which includes the lower edge. The method includes bending of the member by moving of the lower area outwardly assuming a transverse position relative the upper area to define a collection trough to collect falling debris.

A still further embodiment of this invention is where the debris collection tray is constructed from a rectangularly shaped sheet material member.

A still further embodiment of this invention is where the method includes attaching of a securement to the member at the upper edge.

A still further embodiment of this invention is where the method includes using an adhesive strip for the temporary securement.

### BRIEF DESCRIPTION OF THE DRAWING

For a better understanding of the present invention, reference is to be made to the accompanying drawing. It is to be understood that the present invention is not limited to the precise arrangement shown in the drawing.

FIG. 1 is an isometric view of the debris collection tray member of the present invention showing a large quantity of the elongated, thin, sheet material mounted in roll form where a selected length of the rolled material can be removed and severed from the roll obtaining a desired length of a member to be used as a debris collection tray;

FIG. 2 is a front view of the debris collection tray member of the present invention showing the member in its flat or planar configuration;

FIG. 3 is an isometric view showing removal of a covering strip from an adhesive strip which is then used to mount the sheet material member of the debris collection tray of the present invention onto a vertical wall surface;

FIG. 4 is an isometric view similar to FIG. 3 but with the sheet material member being mounted on the vertical wall surface depicting initial engagement of a drill in conjunction with the wall surface just above the sheet material member; and

FIG. 5 is an isometric view similar to FIG. 4 but showing the thin, sheet material member being deformed to form the trough for collecting of falling debris and the generating of that debris by the operation of the drill in conjunction with the wall surface.

### DETAILED DESCRIPTION OF THE INVENTION

Referring particularly to FIG. 2, there is shown a debris collection tray 10 of this invention. The debris collection tray 10 is to be formed of thin, sheet material and is basically elongated in configuration having a basic rectangular shape. However, a rectangular shape is not mandatory but is certainly convenient. The tray 10 has an upper or top edge 12 and a bottom or lower edge 14. Mounted directly adjacent the upper edge 12 on the back side 16 of the member that makes up the tray 10 of this invention is an adhesive strip 18. The adhesive strip 18 may be covered prior to usage by a covering strip 20 although some adhesives don't need a covering strip. The covering strip 20 can be easily manually removed exposing the adhesive strip 18. Although the use of an adhesive strip is desirable, other securement such as hand fasteners (screws, bolts, nails, tacks, etc.) could be used. The member that makes up the tray 10 of this invention also has a front side 22.

The material of construction for the member that makes up the tray 10 of this invention can be constructed of different types of material. However, whatever material it is constructed it is important that the member that makes up the tray 10 be pliable. What is meant by pliable is that the tray 10 can be easily, manually deformed and when deformed will remain in that deformed state. A desirable material would be a metallic foil. Another type of material would be a laminated material composed of paper and foil. It is even deemed to be possible that the member that makes up the tray 10 could be constructed of any plastic or rubber material.

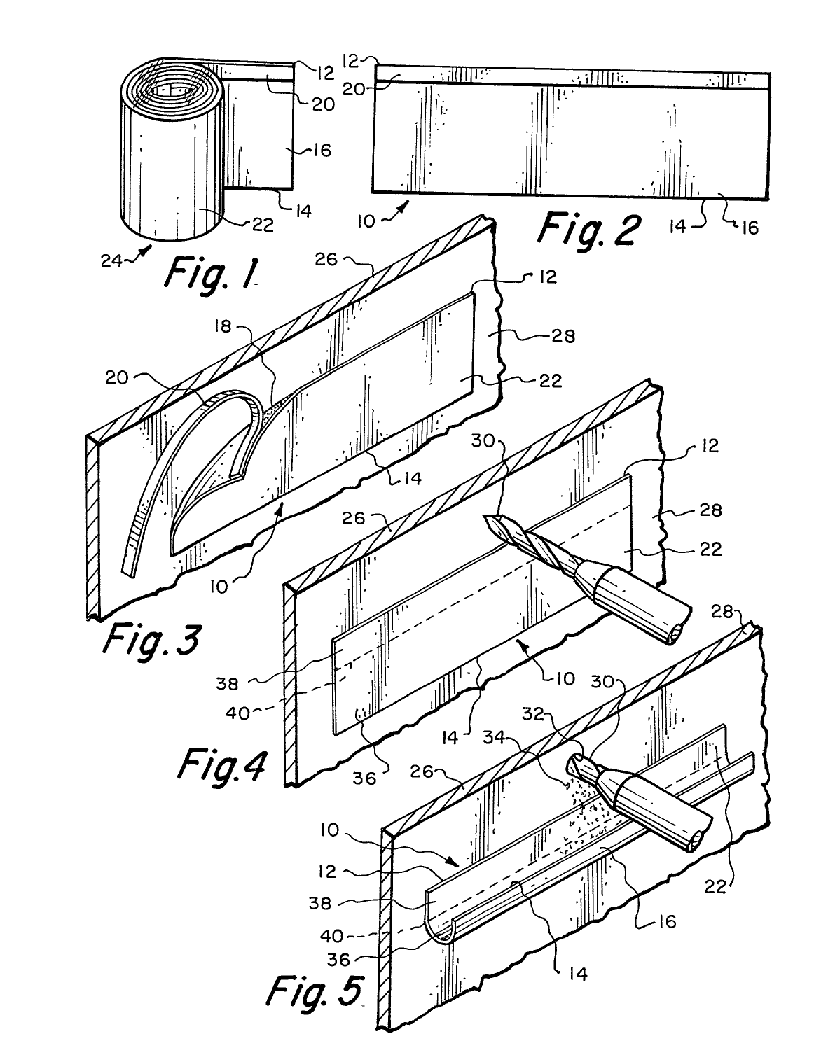

It is envisioned that the member that makes up the tray 10 could be sold within stores in packages with each package containing a plurality of the members each of which comprise a tray 10. A typical length for the member would be about twelve to fourteen inches. However, it is considered to be within the scope of this invention that the length of the member could be increased or decreased. It seems that a desirable width for the member would be about four inches. Again, this could be increased or decreased without departing from the scope of this invention. The thickness of the tray is less than one-sixteenth of an inch. It is also possible that the tray 10 of this invention could be sold in roll form, such is as shown in roll 24 FIG. 1. A selected length could be removed by the user from the roll 24 and then cut to a desired length. Typical users for the roll 24 might possibly be tradesmen, such as painters, carpenters and even homemakers to use in conjunction with counter tops where the homemaker uses the tray to brush crumbs from the surface of the counter top into the tray. Typical roll sizes would be between twenty-five and fifty feet. Therefore, a tradesman may use a length of several feet for the tray 10 or just a matter of a few inches. Also, the product of this invention could be packaged as a stack of the trays 10 with the user just peeling off the uppermost tray 10 from the stack.

Let it be assumed that there is a need to perform some type of operation on a vertical wall 26. The vertical wall 26 has a wall surface 28. Let it be assumed that it is desired to perform a drilling operation by a rotary drill 30 to form a hole 32 within the wall surface 28. In the forming of that hole 32, there will inherently be created debris in the forms of chips, dust or swarf 34.

When the location for the hole 32 has been obtained, the user then takes a selected length of the member that makes up the tray 10 and removes the covering strip 20 exposing the adhesive strip 18. The user then places the member that makes up the tray 10 at a location just below the point at where the hole 32 will be formed. The user then presses the member that makes up the tray 10 against the wall surface 28 which will result in the adhesive strip 18 temporarily holding the member that makes up the tray 10 in its established position on the wall surface 28. The user then manually deforms the lower area 36 relative to the upper area 38 which is divided by imaginary line 40 on the member that makes up the tray 10. The lower area 36 is deformed by hinging at the imaginary line 40 so that the lower area 36 is located transverse relative to the upper area 38. The lower area 36 can be further deformed so that it can form a U-shape so that it forms a trough that facilitates the collecting of the debris 34 during the generating of the hole 32 by the drill 30. When the drilling operation has ended, the debris collecting tray 10 can merely be grabbed, removed and discarded since it is no longer needed.

The user need not make the lower area 36 into a trough 36, but can actually make it into an almost right angled configuration relative to the upper area 38. It is just that if it is made into a trough 36, it does facilitate the collecting and holding of the debris 34.

It is also considered to be within the scope of this invention that the debris collection tray 10 could be utilized to define a border for painting. The upper edge 12 could be placed at the line (masking) where it is desired that the painting should end. If there are any splatters of paint, the tray 10 would also function to collect those splatters within the trough 36 of the tray 10.

The present invention may be embodied in other specific forms without departing from the essential attributes thereof. Reference should be made to the appending claims rather than the foregoing specification as indicating the scope of the invention.

What is claimed is:

1. A debris collection tray comprising:
an elongated, thin, sheet material member having a front surface and a back surface and a top area and a bottom area, said member being pliable so as to be bent from an initial shape to a usable shape;
means for temporary securement of said member onto an exterior structure, said temporary securement located at said top area; and
said usable shape occurs when a user deforms said member by bending said member so said bottom area is located transversely to said top area, whereby said bottom area is capable of collecting debris generated during operation on the exterior structure.

2. The debris collection tray as defined in claim 1 wherein:
said member being rectangular in shape.

3. The debris collection tray as defined in claim 1 wherein:
said means for temporary securement being mounted on said member.

4. The debris collection tray as defined in claim 1 wherein:
said exterior structure comprising a wall.

5. The debris collection tray as defined in claim 1 wherein:
said means for temporary securement comprising an adhesive strip.

6. The method of making and installing a debris collection tray comprising:
forming an elongated, thin, sheet material member having an upper edge and a lower edge where said member is constructed to be pliable and said member has an upper area which includes said upper edge and a lower area which includes said lower edge;
attaching a securement to said member at said upper edge;
mounting of said member by said securement onto an exterior structure at a selected location;
bending of said member by moving of said lower area outwardly assuming a transverse position relative to said upper area; and
whereby said lower area defines a trough which is able to collect falling debris.

7. The method as defined in claim 6 wherein the step of forming includes obtaining a rectangular configuration for said sheet material member.

8. The method as defined in claim 6 wherein the securement comprises an adhesive strip.

9. The method of making a debris collection tray comprising:
forming an elongated, thin, sheet material member having an upper edge and a lower edge where said member is constructed to be pliable and said member has an upper area which includes said upper edge and a lower area which includes said lower edge;
bending of said member by moving of said lower area outwardly assuming a transverse position relative to said upper area; and
whereby said lower area defines a trough which is able to collect falling debris.

10. The method as defined in claim 9 wherein the forming step includes making of said sheet material member into the shape of a rectangle.

11. The method as defined in claim 9 which includes prior to said bending the attaching of a securement to said member at said upper edge.

12. The method as defined in claim 11 wherein the securement comprises an adhesive strip.
